(19) United States
(12) Patent Application Publication
(10) Pub. No.: US 2006/0015998 A1
(43) Pub. Date: Jan. 26, 2006

(54) Heating system for bathing vessels and related structures

(76) Inventors: Ryan L. Whitinger, Flowery Branch, GA (US); Katherine R. Adams, Tucker, GA (US)

Correspondence Address: WALLACE G. WALTER, 5726 CLARENCE AVE, ALEXANDRIA, VA, 22311-1008, US

(21) Appl. No.: 11/183,934

(22) Filed: Jul. 19, 2005

Related U.S. Application Data
(60) Provisional application No. 60/589,805, filed on Jul. 22, 2004.

(51) Int. Cl. A61H 33/02

(52) U.S. Cl. 4/545

(57) ABSTRACT

A bathing structure, such as a tub, spa, shower base, and/or seated shower base, includes an electrical heater element adhered into or embedded within the wall structure of the bathing structure. The electrical heater is preferably formed as a sheet or sheet-like assembly of a heater wire circuit and a support sheet, such as an open-weave fiberglass mesh. The flow of electricity through the wires generates heat that is conducted through the wall of the tub structure to the interior surface of the tub to provide a warm sensation or feeling to the bather upon entry into the bathing structure.

### CROSS-REFERENCE TO RELATED APPLICATION

This application claims the benefit of U.S. Provisional Patent Application 60/589,805 filed Jul. 22, 2004 and in common ownership herewith.

### BACKGROUND OF THE INVENTION

The present invention relates, in general, to bathing structures including, for example, soaker-type bath tubs, whirlpool bath tubs, air bath tubs, shower bases, and seated shower bases.

Various types of bathing structures, including various types of tubs/spas and showers systems have been developed and commercialized over the years. One less than desirable characteristic of these systems relates to the tactile response or “feel” consequent to the initial physical contact made by the bather with the surface materials of the bathing structure; it is common for the surface of the bathing structure to feel uncomfortably cool or cold since the bather's skin temperature is higher than that of the skin-contacting surfaces of the bathing structure. This less-than-desirable tactile sensation is most often felt in the general area of the bather's neck, shoulders, back and posterior regions.

The full scope of applicability of the present invention will become apparent from the detailed description to follow, taken in conjunction with the accompanying drawings, in which like parts are designated by like reference characters.

### SUMMARY OF THE INVENTION

It is an object or goal of the present invention to heat at least some of the surface or surfaces of a bathing structure that comes into contact with the bather's skin to mitigate or eliminate the initial sensation of a cool or cold surface and the accompanying physiologic response, i.e., tensing of the body, to thereby provide increased user comfort, greater relaxation, and an enhanced therapeutic experience.

It is a further object or goal of the present invention to reduce or minimize heat loss of the water used in a bathing structure by heating at least some of the surface or surfaces of a bathing structure that comes into contact with the water.

A heating system in accordance with the present invention includes a bathing structure, such a tub or spa, a seated shower, and/or shower-base fabricated from a suitable material, such an acrylic/fiberglass combination or the like, in which electrical conductors have been embedded in or laminated into at least some of those regions thereof that come into contact with the bather's skin. An appropriately controlled electrical current is selectively passed through the conductors to create heat that, in turn, heats the desired surfaces of the bathing structure to mitigate against or eliminate the initial sensation of a cool or cold surface by the bather.

In one example of the present invention, a bathing structure is fabricated from an acrylic/fiberglass structure; a flexible “sheet” or sheet-like electrical heater is embedded into or laminated into the structure in at least one region thereof designed to come into contact with the bather's skin, such as in the neck, shoulders, back, and/or posterior regions. The use of a sheet-like electrical heater provides an even distribution of warmth to the specified surface area(s) that will come in contact with the bather as warmth is directed to the bather while thus minimizing the undesired sensation of a cold or cool surface.

In a typical tub application, heaters can be provided in the backrest areas and floor areas of the tub that would come in contact with the neck, shoulders, back and posterior. In a shower application, a heater or heaters can be provided in the “base” of the shower and, in seated showers, in the seat portion and in the backrest portion of the shower seat.

### BRIEF DESCRIPTION OF THE DRAWING

FIG. 1 illustrates a perspective view of an exemplary bath, tub, or spa structure showing an electrical heater sheet that this partially co-extensive with the bottom wall and the rear wall of the tub;

FIG. 2 illustrates a side view of the exemplary bath, tub, or spa structure of FIG. 1;

FIG. 3 is an end view of the tub of FIG. 1;

FIG. 4 is a plan view of the basic configuration of a heater assembly;

FIG. 5 is a plan view of a another sheet-like heater having an hour-glass configuration;

FIG. 6 is a first cross-sectional view through the wall section of a tub showing the manner in which the heater is installed in the tub;

FIG. 7 is another cross-sectional view through the wall section of a tub showing the manner in which the heater and associated thermosensor is installed in the tub;

FIG. 7a is an enlarged detailed view of the cross-sectional view of FIG. 7 showing a thermal switch in thermal communication with the heater;

FIG. 8 is a seated shower base in which selected surface portions thereof are heated;

FIG. 9 is a generalized schematic diagram for controlling a heater; and

FIG. 10 is a more specific schematic diagram for controlling a heater or heaters.

### DESCRIPTION OF THE BEST MODE

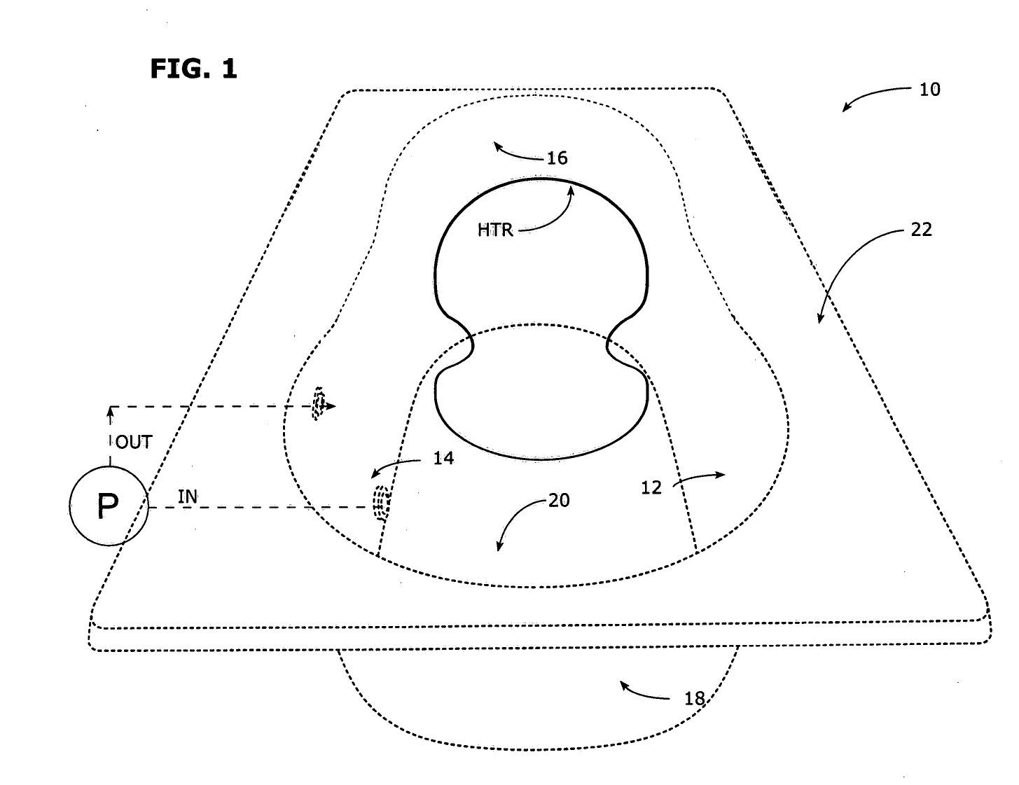

A representative tub in accordance with the present invention is shown in various views in FIGS. 1, 2, and 3 and designated generally therein by the reference character 10. A full description of the tub shown is presented in U.S. patent application Ser. No. 10/407,186 filed Apr. 7, 2003 (now abandoned), the disclosure of which is incorporated herein by reference.

As shown, the tub 10 includes an interior portion having opposed sidewalls 12 and 14, opposed endwalls 16 and 18, and a bottom surface 20. In addition, the tub 10 includes a sill portion 22. In those applications in which the tub is a “jetted-tub” (rather than a conventional “soaker” tub), the tub 10 is part of a larger system that includes a pump P that withdraws water from the interior of the tub 10 through a suction inlet in the tub wall (unnumbered) and an inlet pipe (IN), pressurizes the withdrawn water, and re-introduces the pressurized water into the interior of the tub 10 through a plurality of nozzles or jets as is conventional in this art.

The tub shown in FIGS. 1-3 is shown as an exemplary design only; as can be appreciated, the present invention has broader application and is well-suited for tubs (i.e., “soaker” tubs and “air-bubbler” tubs) and related bathing structures (such as shower bases and seated shower arrangements) of the type that do not have a recirculating water system.

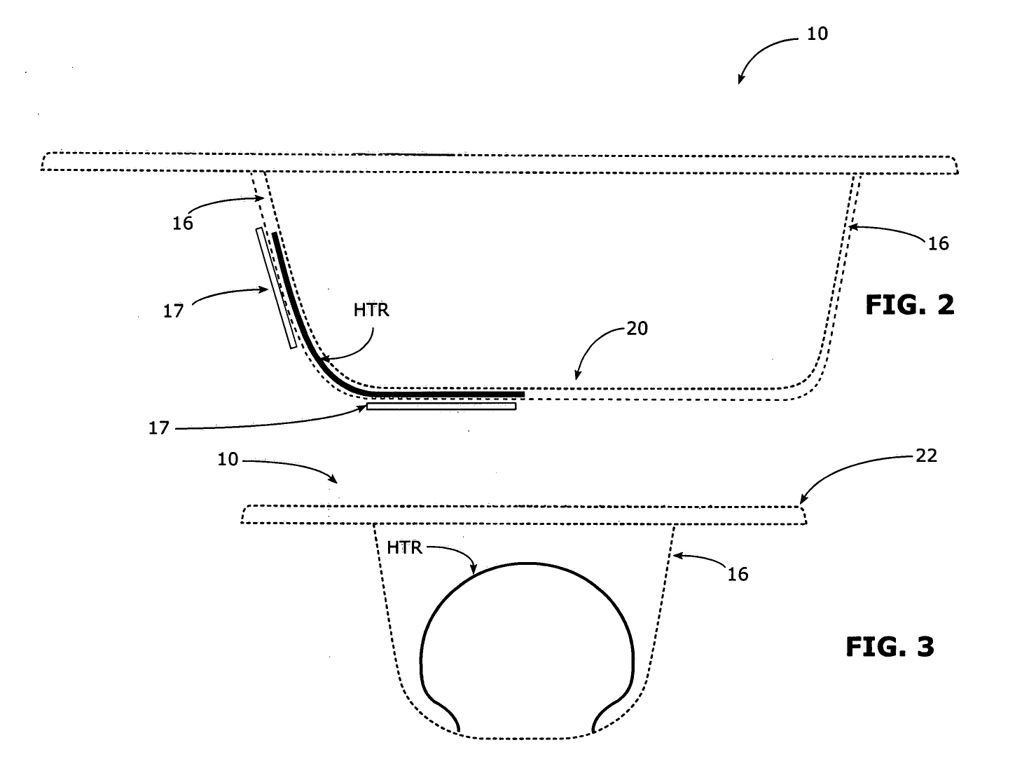

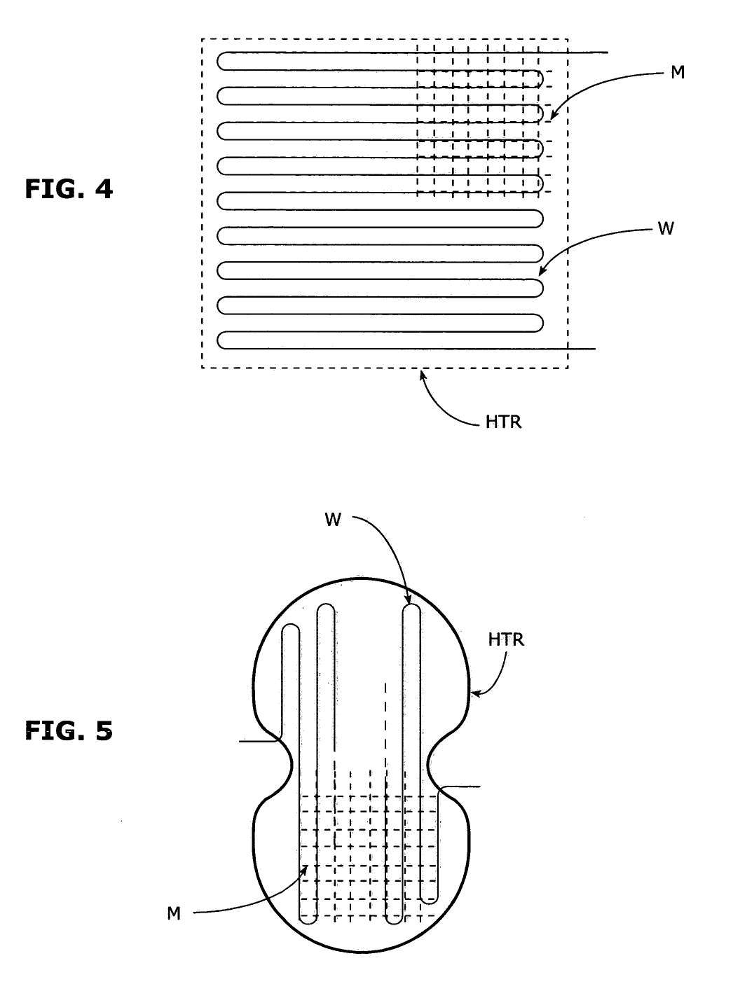

As represented in the various figures, an electrical heater HTR is associated with the tub structure 10. As explained below in relationship to FIGS. 4 and 5, the electrical heater HTR is preferably a sheet-like heater that is embedded in the tub wall 16. As shown in FIG. 2, insulating sheets 17 are attached or secured to the exterior of the tub wall 16 in the general areas of the electrical heater HTR; the insulating sheets 17 function as a heat barrier that retains heat within the tub structure and optionally can include heat-reflective or aluminized surfaces to reflect heat toward the interior of the tub structure.

As shown in FIG. 4, the electrical HTR, in its simplest or basic version, can take shape of a series of back-and-forth loops of insulated electrical wire W mounted on or between rectangular support sheets; in general an open-weave or loose-weave fiberglass mesh is preferred, as explained below, to form a sheet-like assembly of the open-weave fiberglass mesh and the wire W. The sheet heater HTR shown in FIG. 4 can be embedded in the tub wall structure, as explained below, in those areas where the heat effect is desired. Where a plurality of sheet heaters HTR are to be used, the plural heaters HTR can be connected in parallel circuit, series circuit, or in series-parallel circuit as desired.

In the preferred embodiment, the heater HTR is constructed of an open or loose weave fiberglass mesh M (shown in FIG. 4 in dotted-line illustration as orthogonal strands), with low voltage, high-wattage heating wires W woven through the weave or otherwise attached to it. In the preferred form, the wires W are tied to a portion of a strand with threads. The heating wires W are a composite cable fabricated from a nichrome conductive core fitted inside an insulator and covered with a conductive braid. The cable W is attached to a fiberglass mesh M and terminated in “cold end” lead cables. The conductive braid is be connected to earth (ground) to ensure leakage current will be safely carried away in the event of cable failure, due, for example, to mechanical fault. The amount of wire, the gauge of wire, and the placement of wire are all interrelated factors in achieving the correct operation of the system. A change in one feature necessitates altering specifications of the others; for example, within a grid size of 18″×18″ square, 358 inches of 22SWG wire are woven into the fiberglass mesh in a back-and-forth looped pattern (as shown in FIG. 4), with the wires preferably being no more than about ¾″ apart. The specified amount of wire and the distance between wires ensure proper heat distribution without “hot spots”; the specified gauge of wire allows accommodation of the necessary heat ranges. Testing has shown that the wire specifications for a different size heating grid need to be adjusted accordingly in order to provide the same effect. The combination of the amount of wire, gauge of wire W, and position of wire W enables the system to heat up to full high temperature setting from a “cold start” in less than about 30 minutes.

A more sophisticated form of the electrical heater HTR is shown in FIG. 5; the heater HTR is preferably formed as a generalized oval with a “pinched” waist to provide an hourglass-like shape. As shown in FIG. 5, the heater wires W run along the longer axis of the heater HTR; as can be appreciated another orientation, such as along shorter axis is equally acceptable. The heater wires W can be formed as a single circuit as shown in FIG. 4 or as a set of two or more parallel connected wiring patterns. In FIG. 5, the heater HTR is shown with its reduced-width waist intermediate the upper and lower ends of the heater HTR; if desired, the reduced-width waist need not be at the mid-section of the heater HTR.

As an alternative to the open weave fiberglass mesh M discussed above, the heater HTR can be formed from flexible sheets of a polyimide film (i.e., Kapton®) in which a conductive heater pattern is etched or otherwise deposited.

The wire patterns in FIGS. 4 and 5 are shown as back-and-forth loops; as can be appreciated, other patterns, such circular patterns or spiral patterns, are not excluded.

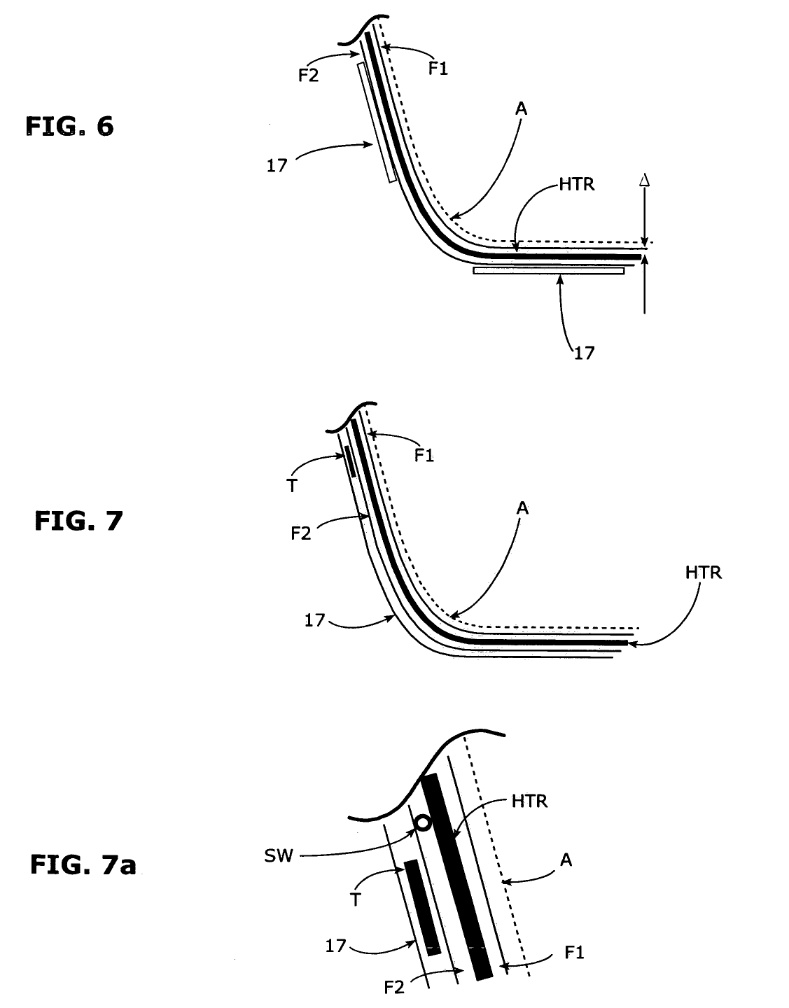

As shown in FIGS. 6, 7, and 7a, the heater HTR is mounted in or embedded within the wall (and/or bottom) structure of the tub 10; more specifically, the electrical heater HTR is positioned within or between inner and outer fiberglass layers, F1 and F2, with a conventional acrylic sheet A provided on the interior portion of the inner fiberglass layer F1. While a bathing structure that uses an acrylic innermost component with a fiberglass support is preferred, other arrangements, including the combination of a Gelcoat with fiberglass as its structural reinforcement is suitable. The bathing structure vessel shell must first be laminated with a fiberglass/resin mixture for structural integrity purposes; a 0.25 inch thickness (A in FIG. 6) for the fiberglass/resin provides a laminate F1 that is thick enough to prevent “print-through” discoloration of the bathing surface by the heating grid as well as providing the requisite electrical insulation. A variant of the arrangement of FIG. 6 is shown in FIG. 7 and includes a thermosensor T that is in thermal contact with or in thermal communication with the fiberglass layer F2 in either direct contact with or in a sufficient heat-conducting relationship to provide an indication of the heater HTR temperature. The thermosensor T is used in conjunction with the below described control circuitry to control heater temperature and may take the form of a thermistor, thermocouple, a bi-state switch with a defined “open” temperature, or other functionally equivalent device. While the thermosensor T is shown in FIG. 7a, for example, as in the insulation layer 17, the thermosensor can optionally be located within the fiberglass layer F2 or integrated directly in the heater HTR assembly.

The electrical heater HTR or heaters are installed by first creating an acrylic shell or pre-form; these shells or pre-forms are typically formed by vacuum molding a heated acrylic sheet. Thereafter, the fiberglass layer F1 is applied and appropriately formed. After this first layer F1 has been laminated and cured, the electrical heater HTR or (in those cases where more than one heater is to be used) each electrical heater HTR is adhered to the back surface of the acrylic/fiberglass structure using a cement-type material to keep the electrical heater HTR in place during application of the next layer of laminate F2. In order to further prevent the undesired “print-through” effect, the electrical heater HTR is applied with the smooth side of the mesh-like grid “face-down” on the first layer F1 of laminate.

A second layer of fiberglass/resin mixture, preferably in thickness equal to or greater than the initial layer F1, is now applied over the heater HTR. This second layer is normally the final layer of laminate and permeates onto and into and integrates with and covers the heater HTR. This second laminate F2 not only protects the heater HTR, but desirably functions to reflects the heat toward the interior surface of the bathing structure and minimizes undesired heat dissipation.

The use of a mesh-like fiberglass fabric M (FIGS. 4 and 5) into or onto which the wires W are attached or connected is the preferred form of the heater HTR since the openings in the fiberglass mesh M allow the second layer F2 of fiberglass/resin mixture to penetrate into and thought the heater HTR to embed or integrate with the first layer F1 of fiberglass/resin mixture that had been applied to the acrylic. The result is that the acrylic shell, the first layer F1 of laminate, the heater HTR, and the second layer F2 of laminate are all bonded together as one unit, with minimal interlayer spaces, voids, or air therebetween to thus minimize the opportunity for undesired delamination.

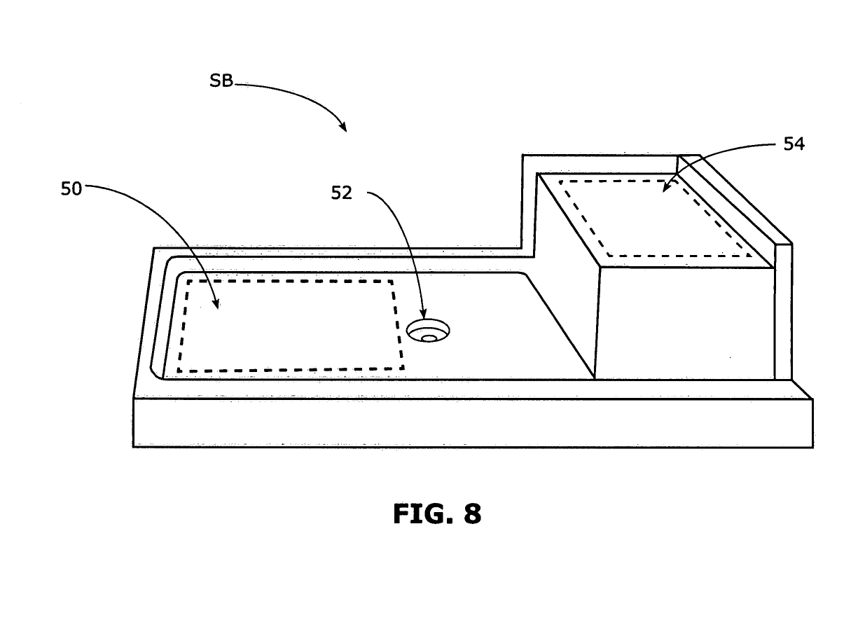

While one application of the present invention is in combination with tubs of various types, including conventional “soaker” tubs as well as the tub represented in FIGS. 1-3, the present invention has applicability in non-tub bathing structures including shower bases and shower-base/seat arrangements. As shown in schematic fashion in FIG. 8, an example or representative shower-base SB includes a base portion 50 having a drain opening 52 and a seat formation 54 adjacent thereto. As shown in dotted-line illustration, one or more heaters HTR can be incorporated into the bathing structure.

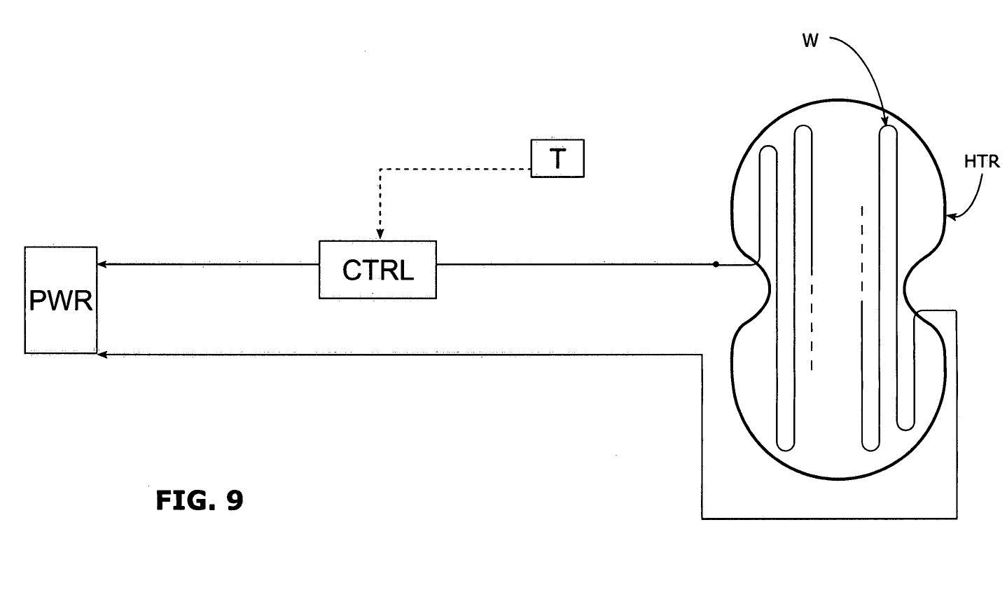

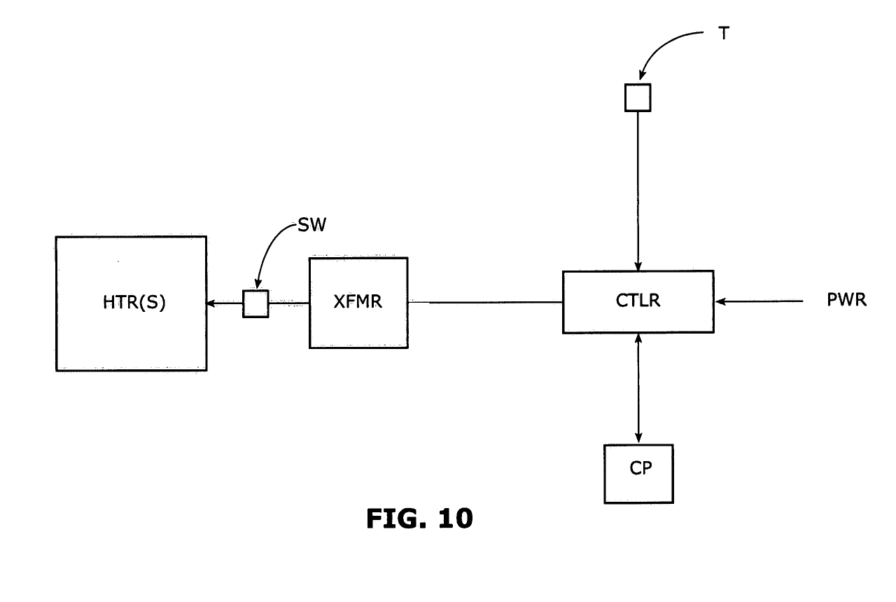

FIG. 9 is a representation of a generalized circuit for controlling the heater HTR; more specific control circuits are shown in FIG. 10. As shown, the heater HTR is connected to a source of power PWR (such as a household circuit) through a suitable controller CTRL. The controller CTRL can take the form of a simple ON/OFF switch or a more sophisticated semiconductor-controller including one that includes temperature controls and a timer that stores one or more timing cycles for the heater HTR. In addition, one or more temperature thermosensor T (FIG. 7) provide temperature information to the controller CTRL. As can be appreciated, appropriate ground-fault or other protective circuitry can be installed in the controller CTRL

FIG. 10 is a specific diagram for controlling the heater HTR; as shown, power is supplied to a controller CTRL that receives temperature control commands from a user-operated control pad CP. The control pad CP is preferably mounted in or on a surface portion of the bathing structure and functions as the user interface. The control pad CP includes an on/off button or switch; up/down arrows for user selection of high/medium/low operational modes, and an LED digital display window for settings and status. In the preferred embodiment, the “low” is a “power saver mode” in which a low current value is constantly applied to the heaters to provide a “pre-heat” condition that allows the heaters to heat up much more rapidly when the high or medium settings are selected at time of use.

The temperature sensor T is mounted to the outer layer F2 of laminate (see FIG. 7a), but “inside” the heat barrier pad 17. The temperature is sensed by a solid-state sensor T which detects surface temperature through the laminated bath wall. Software programming compensates for the insulating effect of the bath material and provides accurate surface temperature monitoring information that is provided to the controller CTRL. It is preferred that the temperature sensor T is located at or near the top of the heater HTR and above the water line, for bather comfort.

A temperature switch SW is incorporated in the system in order to prevent overheating of the bathing vessel surface. The temperature switch SW is typically in the form of a bi-state contact set that is designed to interrupt the circuit (and the supply of electricity) at some over-limit temperature setting; the temperature switch is typically installed in the circuit between the transformer XFMR and heater(s) HTR. It is installed on the “outward” side of one of the heaters HTR and laminated within the outer fiberglass structure F2 (see FIG. 7a). In the unlikely event of an overheating situation, the temperature switch SW will open, effectively cutting off power to the heaters HTR until such time as the temperature returns to the set level. Like the temperature sensor T, the temperature switch is best located at or near the top of the heater HTR.

In addition to the arrangements shown in FIGS. 9 and 10, other control arrangements are know and suitable, for example, control electronics can take the form of a micro-processor controlled device responsive to a software routine or similar devices including an application-specific integrated circuit (ASIC) or dedicated logic devices that control current-switches, for example, various types of silicon-controlled rectifiers (SCR) and/or TRIACS as is known. Although a step-down transformer arrangement is presently preferred, other systems, including those operating and line voltage are not excluded. In a simpler arrangement, heat control can be provided by a simple count-down timer having a fixed maximum time value (i.e., 30-35 minutes) that shuts off power at the end of the time cycle.

As will be apparent to those skilled in the art, various changes and modifications may be made to the illustrated embodiment of the present invention without departing from the spirit and scope of the invention as determined in the appended claims and their legal equivalent.

1. An improved bathing structure, comprising,
a bathing structure having wall structures with surface portions at least one or more portions of which are intended to come into physical or thermal contact with a portion of a bather's body; and
a sheet-like electrical heater within a wall structure for providing heat sufficient to heat at least one surface thereof intended to come into contact with a portion of a bather's body.

2. The bathing structure of claim 1, wherein said bathing structure comprises a tub.

3. The bathing structure of claim 1, wherein said bathing structure comprises a shower base.

4. The bathing structure of claim 1, wherein said bathing structure comprises a shower base having a seat portion.

5. The bathing structure of claim 1, wherein said structure includes at least first and second fiberglass/resin laminates, said electrical heater interposed therebetween.

6. The bathing structure of claim 5, further comprising an electrical control circuit for supplying a flow of electricity through said electrical heater.

7. The bathing structure of claim 6, wherein said electrical control circuit includes a thermosensor for sensing the temperature of or a temperature related to the temperature of said electrical heater.

8. The bathing structure of claim 6, wherein said electrical control circuit includes an over temperature switch for interrupting the flow of electricity to said electrical heater in the event an over temperature condition is detected.

9. The bathing structure of claim 1, wherein said sheet-like electrical heater comprises a support sheet having apertures therein and a heating wire attached in places thereof to one or more portions of the support sheet defining the apertures therein.

10. The bathing structure of claim 1, wherein said sheet-like electrical heater comprises an open-mesh support sheet having apertures therein and a heating wire constrained in places thereof to one or more portions of the mesh structure defining the apertures therein.

11. The bathing structure of claim 1, wherein said structure includes at least first and second fiberglass/resin laminates and said sheet-like electrical heater comprises an open-mesh support sheet having apertures therein and a heating wire constrained in places thereof to one or more portions of the mesh structure defining the apertures therein, said electrical heater interposed between said first and second fiberglass/resin laminates.

12. The bathing structure of claim 11, further comprising an insulating sheet attached to the exterior of the bathing structure in the general area of the electrical heater therein.
